(19) United States
(12) Patent Application Publication
(10) Pub. No.: US 2014/0164014 A1
(43) Pub. Date: Jun. 12, 2014

(54) METHOD FOR PROVIDING HEALTH CARE SERVICE FOR PROVIDING SELF-AWARE REMINDER FOR HEALTH CARE MOTIVATION

(71) Applicants: Sungwoo Kim, Chungju-Si (KR); Seungbum Hong, Seoul (KR)

(72) Inventors: Sungwoo Kim, Chungju-Si (KR); Seungbum Hong, Seoul (KR)

(73) Assignee: LG ELECTRONICS INC., Seoul (KR)

(21) Appl. No.: 14/236,012

(22) PCT Filed: Aug. 19, 2011
(86) PCT No.: PCT/KR2011/006149

§ 371 Date: Jan. 29, 2014

(51) Int. Cl. G06F 19/00

(52) U.S. Cl. CPC G06F 19/3418
USPC 705/2

(57) ABSTRACT

The present specification provides a health care service or system for enabling a user of the health care service to receive efficient health care motivation by displaying, on the screen of a terminal, a self-aware reminder (or indicator) even if an application related to the health care service is not activated. To this end, a method for providing the health care service by means of a terminal, according to one embodiment of the present application, comprises the steps of: obtaining information related to the health care of the user from an application related to the health care service from among a plurality of applications stored in a memory unit of the terminal; on the basis of the information, determining whether or not the health care of the user is carried out correctly; and displaying an indicator illustrating instructions for the health care of the user on the screen of the terminal when the health care of the user is not carried out correctly, wherein the indicator can be displayed on the screen of the terminal when the application related to the health care service is not activated.

### TECHNICAL FIELD

The present disclosure relates to a method of providing health care services through a terminal.

### BACKGROUND ART

In recent years, with an increase of interest in health, studies on health care systems for more effective health care and health devices constituting those health care systems have been continuously carried out. Technologies for health devices capable of checking personal health, such as a fall sensor, a medication sensor, an electrocardiogram sensor and the like into which a blood pressure meter, a blood glucose meter, a body fat analyser, or the like and IT technologies are merged have been continually developed.

A user (customer) of a health care service can check his or her own health status through those health devices. In this case, the user can receive a diagnosis or prescription based on the checked health status, and take care of his or her own health status through this.

The user receives the health care service through a terminal held or carried by himself or herself, and particularly, receives a health care service through an application associated with the health care service. In this case, the application may be stored in the memory of the terminal.

When determined that the user's health status is abnormal, the application may display an indicator for providing the user's motivation for health care to allow the user to normally take care of his or her health on the screen of the terminal held (or provided) by the user.

However, there may be a problem in which the user can receive motivation for health care through the indicator only when the application is being executed.

### DISCLOSURE OF THE INVENTION

An aspect of the present disclosure is to provide a health care service or system capable of displaying a self-aware reminder (or indicator) on a screen of a terminal even when an application associated with the health care service is not activated, thereby allowing a user of a health care service to receive motivation for effective health care.

In order to accomplish the foregoing object, a method of providing a health care service through a terminal according to the present disclosure may include acquiring information associated with a user's health care from an application associated with the health care service among a plurality of applications stored in a memory unit of the terminal; determining whether or not the user's health care is normally carried out based on the information; and displaying an indicator indicating an instruction for the user's health care on a screen of the terminal when the user's health care is not normally carried out, wherein the indicator is displayed on the screen of the terminal when the application associated with the health care service is not activated.

As an example associated with the present disclosure, the information may be at least one of whether or not the user's blood glucose is measured or the user's blood glucose level, whether or not the user's blood pressure is measured or the user's blood pressure value, the user's food intake amount and the user's workrate.

As an example associated with the present disclosure, said determining whether or not the user's health care is normally carried out may be determined based on whether or not blood glucose is measured at the user's defined time, whether or not blood pressure is measured at the user's defined time, or whether or not at least one of the user's blood glucose level, blood pressure value, food intake amount and workrate is out of a target range.

As an example associated with the present disclosure, the method may further include acquiring the location information of the terminal; and determining whether or not the terminal is located out of a predetermined range based on the location information, wherein the indicator is displayed on the screen of the terminal when the terminal is located out of the predetermined range.

As an example associated with the present disclosure, the method may further include acquiring the location information of the terminal; determining whether or not the terminal enters a specific region based on the location information; and displaying an indicator indicating health care information associated with the specific region on the screen of the terminal when the terminal enters the specific region.

As an example associated with the present disclosure, the health care information associated with the specific region may be at least one of a hospital, a pharmacy, a sports center and a health care center associated with the health care service located at the specific region.

As an example associated with the present disclosure, the location information of the terminal may be acquired based on at least one of a mobile communication network, a local area network, and a global positioning system (GPS).

As an example associated with the present disclosure, the method may further include generating a control signal for controlling that a second terminal associated with a health care service displays an indicator indicating that the user's health care is abnormal on the screen of the second terminal, wherein the second terminal is connected to the terminal in a wired or wireless manner.

In order to accomplish the foregoing object, a terminal according to the present disclosure may include a display unit configured to display a screen; a memory unit configured to store a plurality of applications; and a controller configured to acquire information associated with a user's health care from an application associated with the health care service among a plurality of applications stored in the memory unit, determine whether or not the user's health care is normally carried out based on the information, and display an indicator indicating an instruction for the user's health care on a screen of the terminal when the user's health care is not normally carried out, wherein the indicator is displayed on the screen when the application associated with the health care service is not activated.

As an example associated with the present disclosure, the information may be at least one of whether or not the user's blood glucose is measured or the user's blood glucose level, whether or not the user's blood pressure is measured or the user's blood pressure value, the user's food intake amount and the user's workrate.

As an example associated with the present disclosure, said determining whether or not the user's health care is normally carried out may be determined based on whether or not blood glucose is measured at the user's defined time, whether or not blood pressure is measured at the user's defined time, or whether or not at least one of the user's blood glucose level, blood pressure value, food intake amount and workrate is out of a target range.

As an example associated with the present disclosure, the controller may acquire the location information of the terminal, determine whether or not the terminal is located out of a predetermined range based on the location information, and displays the indicator on the screen of the terminal when the terminal is located out of the predetermined range.

As an example associated with the present disclosure, the controller may acquire the location information of the terminal, determine whether or not the terminal enters a specific region based on the location information, and display an indicator indicating health care information associated with the specific region on the screen of the terminal when the terminal enters the specific region.

As an example associated with the present disclosure, the health care information associated with the specific region may be at least one of a hospital, a pharmacy, a sports center and a health care center associated with the health care service located at the specific region.

As an example associated with the present disclosure, the location information of the terminal may be acquired based on at least one of a mobile communication network, a local area network, and a global positioning system (GPS).

According to an embodiment disclosed in the present disclosure, when the user's health care associated with a health care service is not normally carried out, an indicator indicating an instruction for the user's health care may be displayed on the screen of the terminal, wherein the indicator is displayed when an application associated with the health care service is not activated, thereby providing a health care service or system for providing motivation for continuous and effective health care.

In particular, according to a health care service or system in accordance with an embodiment disclosed in the present disclosure, a self-aware reminder based on the user's location may be provided, thereby allowing the user to receive motivation for health care in a more accurate and appropriate circumstance.

### BRIEF DESCRIPTION OF THE DRAWINGS

FIG. 1 is an exemplary view conceptually illustrating the structure of a health care system according to embodiments disclosed in the present disclosure;

FIG. 2 is a block diagram illustrating the configuration of a mobile terminal 100 in the health care system;

FIG. 3 is a block diagram illustrating the configuration of a terminal according to embodiments disclosed in the present disclosure;

FIG. 4 is a flow chart illustrating a method of providing a health care service through a terminal according to embodiments disclosed in the present disclosure;

FIG. 5 is an exemplary view illustrating an example of a method of displaying an indicator according to a first embodiment disclosed in the present disclosure;

FIG. 6 is an exemplary view illustrating another example of a method of displaying an indicator according to a first embodiment disclosed in the present disclosure;

FIG. 7 is an exemplary view illustrating still another example of a method of displaying an indicator according to a first embodiment disclosed in the present disclosure;

FIG. 8 is an exemplary view illustrating a health care service providing method for providing a self-aware reminder based on the user's location according to a second embodiment disclosed in the present disclosure;

FIG. 9 is an exemplary view illustrating a health care service providing method for providing a self-aware reminder based on the user's location according to a modified second embodiment disclosed in the present disclosure; and

FIG. 10 is an exemplary view illustrating a method of displaying an indicator according to a third embodiment disclosed in the present disclosure.

### MODES FOR CARRYING OUT THE PREFERRED EMBODIMENTS

Technologies disclosed in the present disclosure may be applicable to a health care system or a method of providing health care contents. However, technologies disclosed in the present disclosure may be also applicable to all health information providing systems and control methods thereof, mobile terminals (or portable devices) constituting the health information providing systems, health care servers and control methods thereof, and methods of collecting, processing and using health information transmitted in a wired and wireless manner, to which the technical concept of the technologies is applicable.

The health care system in particular relates to a health care service system and a method thereof using a ubiquitous network capable of continuously monitoring locations, health conditions and workrates for a plurality of users in a particular region, implementing the health care and exercise care of the plurality of users, preventing an emergency situation in advance based on the location information, health conditions and workrates, and quickly responding to the occurrence of an emergency situation.

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the concept of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

Furthermore, a suffix “module” or “unit” used for constituent elements disclosed in the following description is merely intended for easy description of the specification, and the suffix itself does not give any special meaning or function.

Furthermore, in the present disclosure, the terms including an ordinal number such as first, second, etc. can be used to describe various elements, but the elements should not be limited by those terms. The terms are used merely for the purpose to distinguish an element from the other element. For example, a first element may be named to a second element, and similarly, a second element may be named to a first element without departing from the scope of right of the invention.

Hereinafter, the embodiments disclosed herein will be described in detail with reference to the accompanying drawings, and the same or similar elements are designated with the same numeral references regardless of the numerals in the drawings and their redundant description will be omitted.

In describing the present disclosure, moreover, the detailed description will be omitted when a specific description for publicly known technologies to which the invention pertains is judged to obscure the gist of the present invention. Also, it should be noted that the accompanying drawings are merely illustrated to easily explain the concept of the invention, and therefore, they should not be construed to limit the technological concept disclosed herein by the accompanying drawings.

In general, a health care system or health information providing system refers to a system for comprehensively providing a health care service by receiving various health care related information from a customer (ordinary person or patient) or providing various health care related information to the customer (ordinary person or patient). For example, the health care system may comprehensively support the search of various medical information, the promotion of customer's health, self-diagnostics, the scheduling of appointments, comparative evaluation information on various products, information required for the management of specialized medical institutions, and online transactions.

In recent years, with an increase of interest in health, studies on health care systems for more effective health care and health devices constituting those health care systems have been continuously carried out. Technologies for health devices capable of checking personal health, such as a fall sensor, a medication sensor, an electrocardiogram sensor and the like into which a blood pressure meter, a blood glucose meter, a body fat analyser, or the like and IT technologies are merged have been continually developed.

Owing to the individual development of such a health care system and a health device related thereto, technologies for comprehensively managing various health care systems and information on health devices related thereto are required, and thus there are provided ISO/IEEE 11073 Personal Health Device (hereinafter, referred to as a “PHD standard”) as a standard related to personal health devices and HL7 as a medical information related international standard.

The PHD standard is a standard for providing interoperability between personal health devices, and the foregoing standard defines specialization for each personal health device upon the 11073-20601 based standards such that personal health devices are operated in a plug-and-play manner.

Communication protocols applicable to the PHD are as follows.

First, the local area communication protocol may include Bluetooth, RFID (Radio Frequency Identification), IrDA (infrared Data Association), UWB (Ultra Wideband), ZigBee, Wireless LAN (protocols such as Bluetooth, 802.11n, etc.), and the like.

In addition, the wireless Internet technology may include WLAN (Wireless LAN), Wi-Fi, WiBro (Wireless Broadband), WiMAX (World Interoperability for Microwave Access), HSDPA (High Speed Downlink Packet Access), and the like.

Furthermore, the wired communication related protocol or interface may include a USB (Universal Serial Bus) port, a HDMI (High-Definition Multimedia Interface) port, a DP (Display Port), a wired/wireless headset port, an external charger port, a wired/wireless data port, a memory card port, a port for connecting a device provided with an identification module, an audio I/O (Input/Output) port, a video I/O (Input/Output) port, an earphone port, and the like.

The HL7 standard provides a standard related to clinical and health data as an international standard mostly used in EHR (Electronic Health Record) systems in a hospital. The HL7 standard largely includes a V2 message and a V3 CDA (Clinical Document Architecture).

A health care system according to embodiments disclosed in the present disclosure may be a total health care system for comprehensively providing health care, appointment scheduling, decision-making, consulting, and online transaction services to customers using a communication network.

Furthermore, a health care system according to embodiments disclosed in the present disclosure may provide the comprehensive health care service through various applications to a customer. For example, the various applications may include at least one of an information search application, a health care application, a medical treatment application, a consulting application, and an electronic commerce application.

The information search application may perform the function of retrieving provider information including specialized medical information, drug information, disease information, hospitals, doctors, pharmacies, pharmaceutical companies and medical device manufacturers, medical related web sites, medical-related comparative evaluation information, and the like.

The health care application as an application of providing health care information for promoting a customer's disease prevention may perform the function of overall personal health care such as public health promotion, self-diagnostics, scheduling of appointments, health care after discharge, and the like. Furthermore, the health care application may perform the role of providing management of customer exercise information and exercise prescription, information on diet and prescription thereof, reservation for health care provides and counselling infrastructure, and health community and health contents. Furthermore, the health care application may perform a customized information service for frequently receiving customer's interested disease information.

The medical treatment application may perform the function of providing information on a patient to a healthcare professional when the healthcare professional takes care of the patient, thereby more effectively and accurately making his or her decision. For example, the information on a patient may be one of diagnosis information, treatment and prescription information.

The consulting information may provide legal, accounting, insurance and opening information required for medical facility management or information on areas of expertise associated with inventory management or the like as well as perform a consulting function through questions and answers with customers using on-line or off-line communication means.

The electronic commerce application supports typical on-line transactions, and may perform the function of managing a series of order, payment, and delivery processes for goods to be purchased by connecting at least one of the relevant shipping center, supplier and distributor when a customer (buyer) wants to purchase his or her desired medicines or medical device based on medical related comparative evaluation information.

Description on the Structure of Health Care System

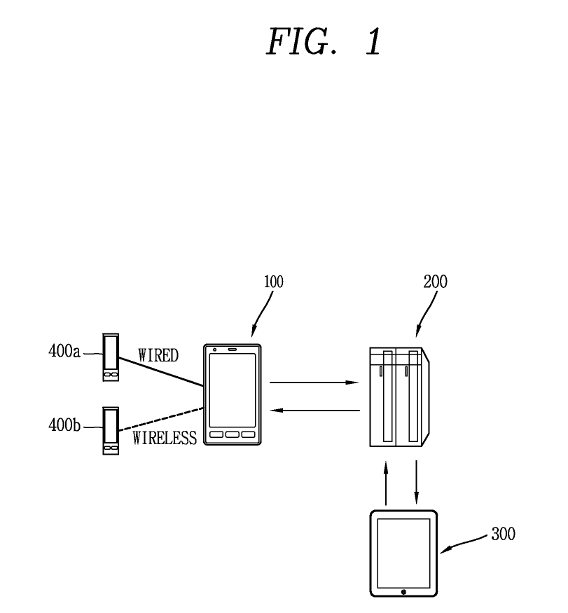

FIG. 1 is an exemplary view conceptually illustrating the structure of a health care system according to embodiments disclosed in the present disclosure.

Referring to FIG. 1, a health care system according to embodiments disclosed in the present disclosure may include a mobile terminal 100 and a health care server 200.

Furthermore, the health care system may further include a professional terminal 300 and a biometric measurement device 400. For example, a professional who uses the professional terminal 300 may include a doctor, a hospital, a pharmacist, a pharmacy, a medical consultant, a health care provider and a veterinarian. There may exist a plurality of biometric measurement devices 400, and the health care system in FIG. 1 may include a first biometric measurement device 400a and a second biometric measurement device 400b.

The constituent elements of the health care system as illustrated in FIG. 1 are not necessarily required, and the mobile terminal may be implemented with greater or less number of elements than those illustrated in FIG. 1.

Hereinafter, the constituent elements will be described in sequence.

The mobile terminal 100 may be functionally connected to at least one of the health care server 200, the professional terminal 300 and the biometric measurement device 400. To this end, the mobile terminal 100 may be connected to at least one of the health care server 200, the professional terminal 300 and the biometric measurement device 400 in a wired or wireless manner to exchange the health or biometric information of the customer (or user) with at least one of the health care server 200, the professional terminal 300 and the biometric measurement device 400.

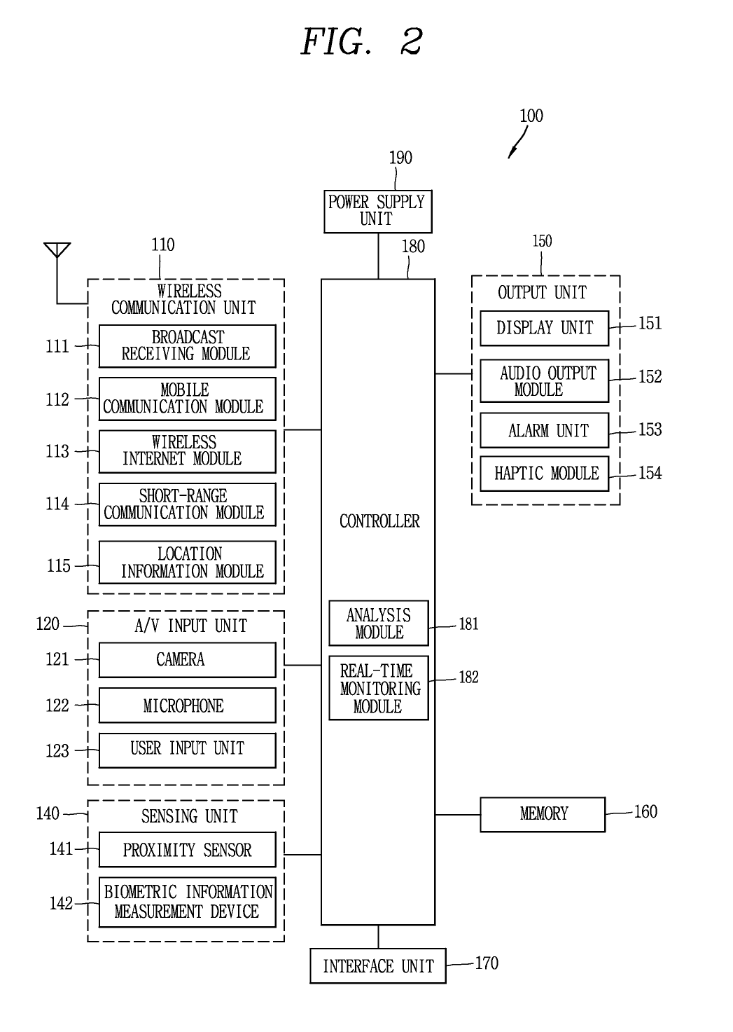

Furthermore, the customer (or user) of the health care system or service may carry the mobile terminal 100, and directly access information on various health care services such as health care, exercise management, medical examination, prescription, appointment, and the like. The mobile terminal 100 will be described later with respect to FIG. 2.

The health care server 200 may perform various functions for managing or controlling the entire health care system. For example, the health care server 200 may generate a survey or prescription related to health care, health status, exercise management or disease through the mobile terminal 100. Furthermore, the health care server 200 may receive information on the status, response of the customer for the survey or compliance with the prescription, and the like, and collect, generate, manage, store, provide or process the information, and transfer the result thereof again to the customer through the mobile terminal 100. To this end, the health care server 200 may include a central processing device (or processor, not shown).

The survey or prescription may be provided in the form of text or in the form of a web view through a web browser. To this end, the central processing device may transmit a script capable of generating the survey or prescription to the mobile terminal 100 or execute the script to transmit the execution result to the mobile terminal 100.

In this case, the mobile terminal 100 may show the script associated with the survey or prescription or the execution result of the script to the customer in the form of text or in a web view manner.

Furthermore, the health care server 200 may be functionally connected to at least one of the mobile terminal 100, the professional terminal 300 and the biometric measurement device 400, and to this end, connected to at least one of the mobile terminal 100, the professional terminal 300 and the biometric measurement device 400 through a wired or wireless communication network. To this end, the health care server 200 may include one or more communication modules (not shown).

Furthermore, the health care server 200 may collect various biometric information on the health care (or remote medical diagnosis) of a customer, information on customer's situation or information on customer's health status, and make database for the various information. To this end, the health care server 200 may be connected to an additional server having a storage medium capable of storing the database in a wired or wireless manner, and may further include a storage unit (not shown) therein.

The professional terminal 300 may be functionally connected to at least one of the health care server 200, the mobile terminal 100 and the biometric measurement device 400, and to this end, connected to at least one of the health care server 200, the mobile terminal 100 and the biometric measurement device 400 through a wired or wireless communication network.

The professional terminal 300 may perform various functions for at least one of customer's remote health care, remote exercise management and remote diagnosis. For example, the professional terminal 300 may transmit and/or receive the customer's health, exercise and medical information to and/or from the health care server 200, and through this, professionals including a doctor, a pharmacist or the like using the professional terminal 300 may remotely perform the customer's health care, exercise management or medical diagnosis.

The biometric measurement device 400 may perform the role of collecting various biometric information required for customer's health care or remote medical diagnosis. To this end, the biometric measurement device 400 may include various sensors and measurement devices for measuring customer's biometric information. For example, the biometric measurement device 400 may include at least one of a blood pressure meter, a blood glucose meter, a body fat analyser, an electrocardiogram sensor and the like. Furthermore, for example, the biometric measurement device 400 may include a fall sensor, a medication sensor, or other sensors capable of checking the customer's status into which IT technologies are merged.

Furthermore, the biometric measurement device 400 may include a sensor capable of measuring the user's workrate and caloric consumption based on the workrate or the like. The workrate may be calculated by acceleration, a number of steps, and the like. In addition, it should be understood by those skilled in the art that sensors capable of measuring various customer's biometric information, customer's condition or customer's status are provided in the biometric measurement device 400.

There are an electrocardiogram (ECG) sensor, a photoplethysmography (PPG) sensor and the like as a sensor for extracting information associated with heartbeat. In particular, PPG is a method for extracting information associated with heartbeat using a predetermined number of LEDs and optical detectors. Heartbeat detection using the PPG may be measured through only one contact point with a body using a simple sensor module, and thus more conveniently used compared to a method of using electrocardiogram or ECG in which two or more electrodes should be adhered.

The customer's biometric information may be the biometric information of a chronically ill patient, for example, information on pulse rate in case of a hypertensive patient, information on blood sugar level on in case of a diabetic patient, and information on electrocardiogram and pulse rate in case of a heart disease patient. Furthermore, the customer's biometric information may be a customer's workrate, a customer's body fat index, a customer's caloric value for digested food, a customer's biorhythm, and the like. In addition, it should be understood by those skilled in the art that various biometric information required for customer's health care or remote diagnosis are applicable to a health care system disclosed in the present disclosure.

Furthermore, the biometric measurement device 400 may collect context information on various types of customers for directly or indirectly showing a customer's body situation. For example, situation information on the customer, as information for stipulating the features of a situation such as a person, a place, a thing, an object, a time and the like that exerts an effect on interactions between a user and another user, system or device applications in association with ubiquitous computing, may include a computing context such as network connectivity, communication bandwidth, printer, display, workstation and the like, a user context such as user's profile, location, people around and the like, a physical context such as lighting, noise level, traffic condition, temperature and the like, and a time context such as time, week, month, season and the like.

According to a method of implementing the health care system, the biometric measurement device 400 may be provided in the mobile terminal 100 to measure a customer's biometric information. In this case, the mobile terminal 100 may additionally have a biometric module.

When the biometric measurement device 400 is separately formed from the mobile terminal 100, the biometric measurement device 400 may be connected to the mobile terminal 100 or the health care server 200 in a wired or wireless manner. For example, the biometric measurement device 400 may form a Bluetooth network through an access point (AP) to be connected to the mobile terminal 100 or the health care server 200 in a wireless manner.

In this case, the biometric measurement device 400 measures biometric information (for example, blood glucose, button portion, body composition, etc.) on a customer (or user) subject to health management, and transmits the biometric information to the mobile terminal 100 or the health care server 200 through the access point (AP) based on a wireless communication scheme.

In case of a plurality of customers (or users), the biometric measurement device 400 may identify the user through user identification (ID) information, and biometric information for each of the user identification (ID) information. In other words, when the measured biometric information is body component information, self identification (ID) information may be incorporated into the biometric measurement device 400 to identify a user so as to distinguish the user for each ID when ID is set during the measurement of biometric information, and the identification (ID) information may be used to distinguish the user during data management even in the health care server 200.

Description of Mobile Terminal in Health Care System

FIG. 2 is a block diagram illustrating the configuration of a mobile terminal 100 in the health care system. The mobile terminal 100 may be implemented in various forms. For example, the mobile terminal (mobile phone) 100 may include a portable terminal, a smart phone, a laptop computer, a digital broadcast terminal, a personal digital assistant (PDA), a portable multimedia player (PMP), and the like.

As illustrated in FIG. 2, the mobile terminal 100 may include a wireless communication unit 110, an Audio/Video (A/V) input unit 120, a user input unit 130, a sensing unit 140, an output unit 150, a memory 160, an interface unit 170, a controller 180, a power supply unit 190, and the like. However, the constituent elements of the mobile terminal 100 as illustrated in FIG. 2 are not necessarily required, and the mobile terminal 100 may be implemented with greater or less number of elements than those elements illustrated in FIG. 2.

The wireless communication unit 110 typically includes one or more modules allowing radio communication between the mobile terminal 100 and a wireless communication system, or allowing radio communication between radio communication the mobile terminal 100 and a network in which the mobile terminal 100 is located. For example, the wireless communication unit 110 may include a broadcast receiving module 111, a mobile communication module 112, a wireless Internet module 113, a short-range communication module 114, a location information module 115, and the like.

As described above, the mobile terminal 100 may be functionally connected to at least one of the health care server 200, the professional terminal 300 and the biometric measurement device 400. To this end, the mobile terminal 100 may be connected to at least one of the health care server 200, the professional terminal 300 and the biometric measurement device 400 through the wireless communication unit 110 to exchange the health or biometric information of the customer (or user) with at least one of the health care server 200, the professional terminal 300 and the biometric measurement device 400.

The broadcast receiving module 111 receives broadcast signals and/or broadcast associated information from an external broadcast management server through a broadcast channel. The broadcast channel may include a satellite channel and/or a terrestrial channel. The broadcast management server may mean a server that generates and transmits a broadcast signal and/or broadcast associated information or a server that receives a previously generated broadcast signal and/or broadcast associated information and transmits to the mobile terminal 100. The broadcast associated information may mean information regarding a broadcast channel, a broadcast program, a broadcast service provider, and the like. The broadcast signal may include a TV broadcast signal, a radio broadcast signal and a data broadcast signal as well as a broadcast signal in a form that a data broadcast signal is combined with the TV or radio broadcast signal.

On the other hand, the broadcast associated information may also be provided through a mobile communication network, and in this case, the broadcast associated information may be received by the mobile communication module 112. The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may receive a broadcast signal using various types of broadcast systems. In particular, the broadcast receiving module 111 may receive a digital broadcast signal using a digital broadcast system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and the like. The broadcast receiving module 111 is, of course, configured to be suitable for every broadcast system that provides a broadcast signal as well as the above-mentioned digital broadcast systems. The broadcast signal and/or broadcast-associated information received through the broadcast receiving module 111 may be stored in the memory 160.

The mobile communication module 112 transmits and/or receives a radio signal to and/or from at least one of a base station, an external terminal and a server over a mobile communication network. Here, the radio signal may include a voice call signal, a video call signal and/or various types of data according to text and/or multimedia message transmission and/or reception.

The wireless Internet module 113 means a module for supporting wireless Internet access. The wireless Internet module 113 may be built-in or externally installed to the mobile terminal 100. Here, it may be used a wireless Internet access technique including a WLAN (Wireless LAN), Wi-Fi, WiBro (Wireless Broadband), WiMAX (World Interoperability for Microwave Access), HSDPA (High Speed Downlink Packet Access), and the like.

The short-range communication module 114 is a module for supporting a short-range communication. Here, it may be used a short-range communication technology including Bluetooth, Radio Frequency IDentification (RFID), Infrared Data Association (IrDA), Ultra WideBand (UWB), ZigBee, Wireless LAN (protocols such as Bluetooth, 802.11n, etc.) and the like.

The location information module 115 is a module for checking or acquiring a location of the mobile terminal. A GPS module is an example. The GPS module receives location information from a plurality of satellites. Here, the location information may include coordinate information represented by latitude and longitude values. For example, the GPS module may measure an accurate time and distance from three or more satellites, and accurately calculate a current location according to trigonometry based upon three different distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. For the location information module 115, a Wi-Fi positioning system and/or a hybrid positioning system may be applicable thereto.

The A/V(audio/video) input unit 120 receives an audio or video signal, and the NV (audio/video) input unit 120 may include a camera 121 and a microphone 122. The camera 121 processes an image frame, such as still picture or video, obtained by an image sensor in a video phone call or image capturing mode. The processed image frame may be displayed on a display unit 151.

The image frames processed by the camera 121 may be stored in the memory 160 (or other storage medium) or transmitted through the wireless communication unit 110. Two or more cameras 121 may be provided according to the configuration type and/or use environment of the mobile terminal.

The camera 121 may be used to check or monitor a customer's (or user's) health status or customer's current situation in a health care system. For example, the camera 121 may continuously capture the customer to monitor the customer's health status and workrate, thereby applying them to the customer's health care or exercise management. Furthermore, the 100 may analyze the capture result of the camera 121 to determine whether or not the customer's status is a dangerous situation, and transfer information on the situation to the health care server 200 connected thereto in a wired or wireless manner when in a dangerous situation. In this case, the health care server 200 may analyze and process information on the situation to transfer emergency treatment or action instructions for the situation to the customer through the mobile terminal 100. Through this, the health care system may provide services capable of preventing an emergency situation for the customer in advance, as well as quickly coping with the occurrence of an emergency situation.

The microphone 122 receives an external audio signal through a microphone in a phone call mode, a recording mode, a voice recognition mode, and the like, and processes the audio signal into electrical voice data. The processed voice data may be converted and outputted into a format capable of being transmitted to a mobile communication base station through the mobile communication module 112 in the phone call mode. The microphone 122 may implement various types of noise canceling algorithms to cancel noise generated in a procedure of receiving the external audio signal.

The user input unit 130 may generate input data to control an operation of the mobile terminal. The user input unit 130 may be configured by including a keypad, a dome switch, a touch pad (pressure/capacitance), a jog wheel, a jog switch, and the like. Particularly, when the touch pad forms an interlayer structure together with a display unit 151, it may be called a touch screen.

The sensing unit 140 detects a current status of the mobile communication terminal 100 such as an opened or closed state of the mobile communication terminal 100, a location of the mobile communication terminal 100, the presence or absence of user contact, an orientation of the mobile communication terminal 100, an acceleration or deceleration movement of the mobile communication terminal 100, and the like, and generates a sensing signal for controlling the operation of the mobile communication terminal 100. For example, when the mobile communication terminal 100 is a slide phone type, it may sense an opened or closed state of the slide phone. Furthermore, the sensing unit 140 takes charge of a sensing function associated with whether or not power is supplied from the power supply unit 190, whether or not an external device is coupled with the interface unit 170.

Furthermore, the sensing unit 140 may measure a customer's biometric information using a health care system. The customer's biometric information may be the biometric information of a chronically ill patient, for example, information on pulse rate in case of a hypertensive patient, information on blood sugar level on in case of a diabetic patient, and information on electrocardiogram and pulse rate in case of a heart disease patient. Furthermore, the customer's biometric information may be a customer's workrate, a customer's body fat index, a customer's caloric value for digested food, a customer's biorhythm, and the like. In addition, it should be understood by those skilled in the art that various biometric information required for customer's health care or remote diagnosis are applicable to a health care system disclosed in the present disclosure.

The sensing unit 140 may further include a biometric information measurement device 142 to measure the biometric information. As described above, the mobile terminal 100 may be connected to the biometric measurement device 400 physically separated therefrom in a wired or wireless manner to receive the biometric information, but the biometric information measurement device 142 may be additionally provided in the sensing unit 140 to collect the biometric information.

Furthermore, the biometric information measurement device 142 may collect context information on various types of customers for directly or indirectly showing a customer's body situation. For example, situation information on the customer, as information for stipulating the features of a situation such as a person, a place, a thing, an object, a time and the like that exerts an effect on interactions between a user and another user, system or device applications in association with ubiquitous computing, may include a computing context such as network connectivity, communication bandwidth, printer, display, workstation and the like, a user context such as user's profile, location, people around and the like, a physical context such as lighting, noise level, traffic condition, temperature and the like, and a time context such as time, week, month, season and the like.

The interface unit 170 may perform the role of interfacing with all external devices connected to the mobile terminal 100. The interface unit 170 may include, for example, a universal serial bus (USB) port, a high-definition multimedia interface (HDMI) port, a display ports (DP), a wired/wireless headset port, an external charger port, a wired/wireless data port, a memory card port, a port for coupling devices having an identification module, audio Input/Output (I/O) ports, video I/O ports, earphone ports, and the like. Here, the identification module may be configured as a chip for storing various information required to authenticate an authority to use the mobile terminal 100, which may include a User Identity Module (UIM), a Subscriber Identity Module (SIM), a Universal Subscriber Identity Module (USIM) and the like. Also, the device having the identification module (hereinafter, referred to as “identification device”) may be implemented in a type of smart card. Hence, the identification device can be coupled to the mobile terminal 100 via a port. The interface unit 170 may receive data or power from an external device to transfer it to each constituent element in the mobile terminal 100 or transmit data within the mobile terminal 100 to the external device.

As described above, the mobile terminal 100 may be functionally connected to at least one of the health care server 200, the professional terminal 300 and the biometric measurement device 400. To this end, the mobile terminal 100 may be connected to at least one of the health care server 200, the professional terminal 300 and the biometric measurement device 400 through the interface unit 170 in a wired manner to exchange the health or biometric information of the customer (or user) with at least one of the health care server 200, the professional terminal 300 and the biometric measurement device 400.

The output unit 150 is configured to provide an output for audio signal, video signal, or alarm signal, and the output unit 150 may include the display unit 151, an audio output module 152, an alarm unit 153, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call. When the mobile terminal 100 is in a video call mode or image capture mode, the display unit 151 may display a captured image and/or received image, a UI or GUI.

The display unit 151 may include at least one of a liquid crystal display, a thin film transistor-liquid crystal display, an organic light emitting diode display, a flexible display, an a three-dimensional (3D) display. Two or more display units 151 may be implemented according to a configured aspect of the mobile terminal 100. For instance, both an external display unit (not shown) and an internal display unit (not shown) may be provided in the mobile terminal 100.

When the display unit 151 and a touch sensitive sensor (hereinafter, referred to as a “touch sensor”) have an interlayer structure (hereinafter, referred to as a “touch screen”), the display unit 151 may be used as an input device rather than an output device. The touch sensor may be implemented as a touch film, a touch sheet, a touch pad, and the like.

Furthermore, the touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also a touch pressure. When there is a touch input to the touch sensor, the corresponding signals are transmitted to a touch controller (not shown). The touch controller processes the received signals, and then transmits corresponding data to the controller 180. Accordingly, the controller 180 may sense which region of the display unit 151 has been touched. Furthermore, the controller 180 can perform a pattern recognition processing so as to recognize writing or drawing input carried out on the touch screen as text or image.

The proximity sensor 141 may be arranged at an inner region of the mobile terminal 100 covered by the touch screen, or near the touch screen. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor has a longer lifespan and a more enhanced utility than a contact sensor.

The proximity sensor 141 may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

Hereinafter, for the sake of convenience of brief explanation, a status that the pointer is positioned to be proximate onto the touch screen without contact will be referred to as “proximity touch”, whereas a status that the pointer substantially comes in contact with the touch screen will be referred to as “contact touch”. For the position corresponding to the proximity touch of the pointer on the touch screen, such position corresponds to a position where the pointer faces perpendicular to the touch screen upon the proximity touch of the pointer.

Furthermore, the proximity sensor 141 senses proximity touch, and proximity touch patterns (e.g., distance, direction, speed, time, position, moving status, etc.). Information relating to the sensed proximity touch and the sensed proximity touch patterns may be output onto the touch screen.

The audio output module 152 may output audio data received from the wireless communication unit 110 or stored in the memory 160, in a call-receiving mode, a call-placing mode, a recording mode, a voice recognition mode, a broadcast reception mode, and so on. The audio output module 152 may output audio signals relating to functions performed in the mobile terminal 100, e.g., sound alarming a call received or a message received, and so on. The audio output module 152 may include a receiver, a speaker, a buzzer, and so on.

The alarm 153 outputs signals notifying occurrence of events from the portable terminal 100. The events occurring from the mobile terminal may include call received, message received, key signal input, touch input, and so on. The alarm 153 may output not only video or audio signals, but also other types of signals such as signals notifying occurrence of events in a vibration manner. When a call signal or message is received, the alarm 153 may output a vibration to notify this. Otherwise, when a key signal is inputted, the alarm 153 may output a vibration as a feedback to the inputted key signal. Through the foregoing vibration output, the user can recognize an event occurrence. The signal for notifying an event occurrence may be also outputted through the display unit 151 or the audio output module 152.

The haptic module 154 generates various tactile effects which a user can feel. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 154 may generate various tactile effects, including not only vibration, but also arrangement of pins vertically moving with respect to a skin being touched, air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 154 may be configured to transmit tactile effects through a user's direct contact, or a user's muscular sense using a finger or a hand. The haptic module 154 may be implemented in two or more in number according to the configuration of the mobile terminal 100. For example, it may be provided in a steering wheel, a gearshift lever, a seat, and the like.

The memory 160 may store a program for processing and controlling the controller 180. Alternatively, the memory 160 may temporarily store input/output data (e.g., a customer's unique ID, etc.).

Furthermore, the memory 160 may store a customer's real-time monitoring results by means of the mobile terminal 100 such as the customer's health status, workrate check or status of compliance with a prescription for disease, and the like.

Furthermore, the memory 160 may store customer information (for example, user's measurement history, etc.) analyzed and processed by the controller 180 with a database.

Furthermore, the memory 160 may store a customer's biometric information measured through the biometric information measurement device 142, and the customer's image or picture captured through the camera 121.

Also, the memory 160 may store data related to various patterns of vibrations and sounds outputted upon the touch input on the touch screen. The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the mobile terminal 100 may operate a web storage which performs the storage function of the memory 160 on the Internet.

The interface unit 170 may generally be implemented to interface the mobile device with external devices. The interface unit 170 may allow a data reception from an external device, a power delivery to each component in the mobile terminal 100, or a data transmission from the mobile terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like. Here, the identification module may be configured as a chip for storing various information required to authenticate an authority to use the mobile terminal 100, which may include a User Identity Module (UIM), a Subscriber Identity Module (SIM), and the like. Also, the device having the identification module (hereinafter, referred to as “identification device”) may be implemented in a type of smart card. Hence, the identification device can be coupled to the mobile terminal 100 via a port. The interface unit 170 may receive data or power from an external device to transfer it to each constituent element in the mobile terminal 100 or transmit data within the mobile terminal 100 to the external device.

The interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals or power inputted from the cradle may operate as signals for recognizing that the mobile device has accurately been mounted to the cradle.

The controller 180 typically controls the overall operations of the mobile terminal 100 for providing a health care service to a customer. For example, the controller 180 may perform the control and processing in association with collecting the customer's biometric information, displaying a survey or prescription generated from the health care server 200 on the screen, and transferring the customer's response to this to the health care server 200.

The controller 180 may include an analysis module 181. Furthermore, the controller 180 may further include a real-time monitoring module 182. All the constituent elements may not be necessarily required to provide a health care system or server, and the controller 180 may be implemented with greater or less number of elements than those illustrated in the above.

The analysis module 181 may perform the role of analyzing various information on a customer. For example, the analysis module 181 may analyze, process and handle the measured customer's biometric information, and store the results with a database in the memory 160.

Furthermore, the analysis module 181 may transfer the customer's biometric information to the health care server 200, thereby allowing the health care server 200 to perform diagnosis for the customer's health care, exercise management and disease or treatment for disease, and the like.

Furthermore, the analysis module 181 may determine whether or not there is an error for various biometric information on the measured customer, and control the biometric information measurement sensor to make a re-measurement when there is an error as a result of the determination.

The real-time monitoring module 182 may perform the role of controlling the camera 121 or the biometric information measurement device 142 to monitor the customer in a real-time manner to check the customer's health status, customer's workrate or compliance with a specialist's prescription in a health care system.

Furthermore, the real-time monitoring module 182 may store the real-time monitoring results with a database in the memory 160.

Furthermore, the real-time monitoring module 182 may transfer the real-time monitoring results to the health care server 200, and thus the health care server 200 may analyze, process and handle the real-time monitoring results to perform diagnosis or treatment according to the results.

The power supply unit 190 receives external power and internal power under the control of the controller 180 to provide power required by various components.

The function of a constituent element applied to the mobile terminal 100 may be implemented in a medium that can be read by a computer or similar device using software, hardware, or any combination thereof. For hardware implementation, it may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units designed to perform the functions described herein. In some cases, such embodiments may be implemented in the controller 180 itself. For software implementation, the embodiments such as procedures or functions may be implemented together with separate software modules. The software modules may perform at least one function or operation described herein. Software codes can be implemented by a software application written in any suitable programming language. The software codes may be stored in the memory 160 and executed by the controller 180.

Description on the Configuration of Terminal According to Embodiments Disclosed in the Present Disclosure

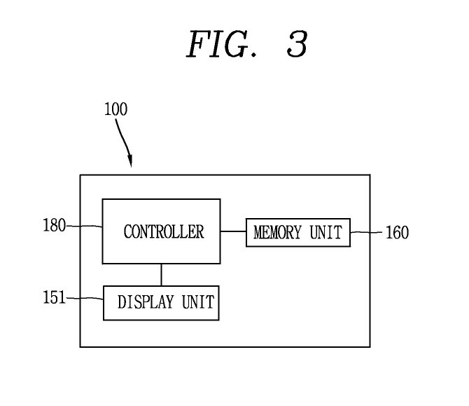

FIG. 3 is a block diagram illustrating the configuration of a terminal according to embodiments disclosed in the present disclosure.

Referring to FIG. 3, the terminal 100 according to embodiments disclosed in the present disclosure may include the controller 180. Furthermore, the terminal 100 may further include a memory unit 160 and a display unit 151. In addition, the terminal 100 may further include various constituent elements to perform a health care service for providing a self-aware reminder for health care motivation.

The constituent elements of the terminal 100 as illustrated in FIG. 3 are not necessarily required, and the mobile terminal may be implemented with greater or less number of elements than those illustrated in FIG. 1.

Here, the terminal in FIG. 3 may be configured in a stand-alone manner as well as applicable to various terminals such as a mobile terminal, a telematics terminal, a smart phone, a portable terminal, a personal digital assistant (PDA), a portable multimedia player (PMP), a desktop pc, a laptop computer, a tablet PC), WiBro terminal, Internet Protocol Television (IPTV) terminal, a television set, 3D television set, an image device, a navigation terminal, an audio video navigation (AVN) terminal, and the like.

Hereinafter, the constituent elements will be described in sequence.

The controller 180 may control various constituent elements constituting the terminal 100 to provide a self-aware reminder for health care motivation to the user of the health care service.

The controller 180 may acquire information associated with the user's health care from an application associated with the health care service among a plurality of applications stored in the memory unit 160.

For example, the application associated with the health care service may be an application for providing a health care service using a ubiquitous network capable of continuously monitoring locations, health conditions and workrates for a plurality of users in a particular region, implementing the health care and exercise care of the plurality of users, preventing an emergency situation in advance based on the location information, health conditions and workrates, and quickly responding to the occurrence of an emergency situation.

Furthermore, for example, information associated with the user's health care may be at least one of whether or not the user's blood glucose is measured or the user's blood glucose level, whether or not the user's blood pressure is measured or the user's blood pressure value, the user's food intake amount and the user's workrate.

Furthermore, the controller 180 may determine whether or not the user's health care is normally carried out based on the information associated with the user's health care.

The determination of whether or not the user's health care is normally carried out may be determined based on whether or not blood glucose is measured at the user's defined time, whether or not blood pressure is measured at the user's defined time, or whether or not at least one of the user's blood glucose level, blood pressure value, food intake amount and workrate is out of a target range.

For example, the controller 180 may determine that the user's health care is not normally carried out in case the user does not measure blood glucose (or blood pressure), in case the user's blood glucose level (or blood pressure value) is out of a target blood glucose (or blood pressure) range, in case the user's food intake amount exceeds a target food intake amount or in case the user's workrate is less than a target workrate.

Furthermore, when the user's health care is not normally carried out based on the determination results, the controller 180 may display an indicator indicating an instruction for the user's health care on the screen of the terminal.

Here, the indicator may be displayed on the screen of the terminal when an application associated with the health care service is not activated.

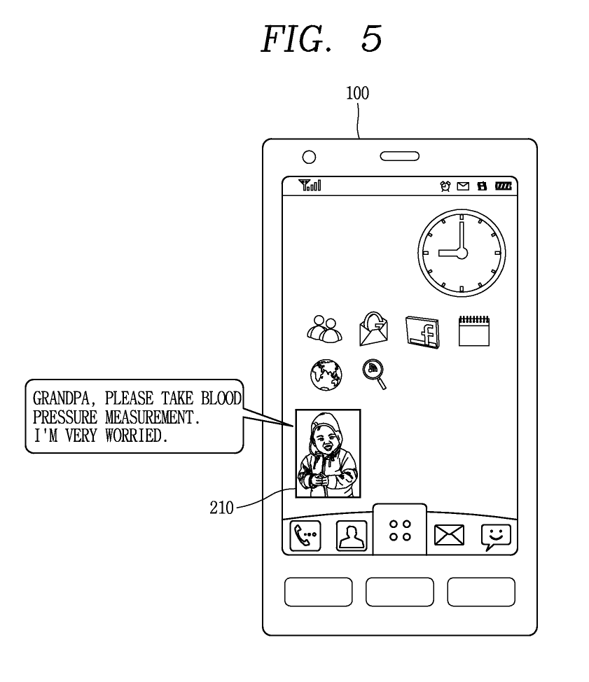

The display of an indicator by means of the terminal will be described in detail with reference to FIGS. 5 through 7.

The memory unit 160 may store the customer's real-time monitoring results by means of the mobile terminal 100 such as the user's health status, workrate check or status of compliance with a prescription for disease, and the like.

Furthermore, the memory 160 may store customer information (for example, user's measurement history, etc.) analyzed and processed by the controller 180 with a database.

The memory unit 160 according to embodiments disclosed in the present disclosure may store a plurality of applications including an application associated with a health care service.

Furthermore, the memory unit 160 may transfer information associated with the user's health care provided by the application associated with a health care service to the controller 180.

As described above, the information associated with the user's health care may be at least one of whether or not the user's blood glucose is measured or the user's blood glucose level, whether or not the user's blood pressure is measured or the user's blood pressure value, the user's food intake amount and the user's workrate.

The display unit 151 may display an image associated with a health care service. In other words, the display unit 151 may display and output information processed by the terminal 100. For example, the terminal 100 may display a user interface (UI) or graphical user interface (GUI) for providing the health care service to a user (or customer).

The display unit 151 according to embodiments disclosed in the present disclosure may display an indicator indicating an instruction for the user's health care when the controller 180 determines that the user's health care is not normally carried out.

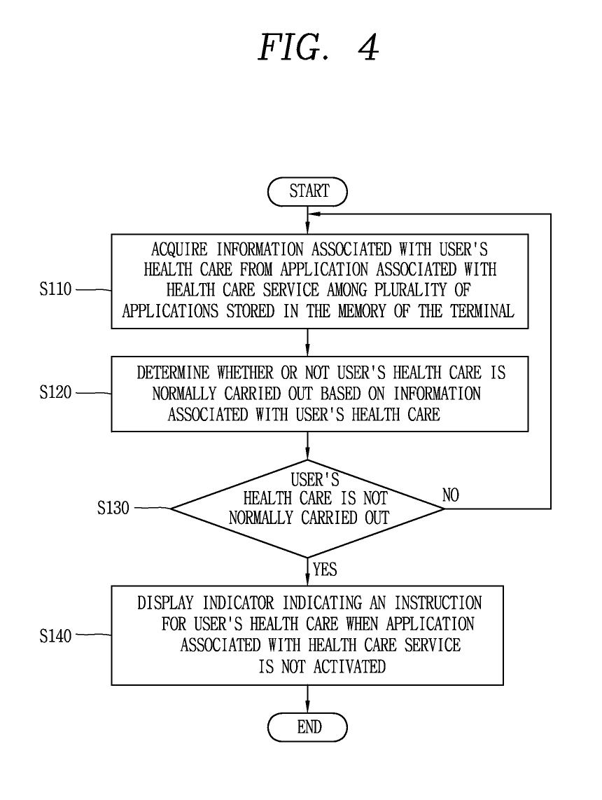

Hereinafter, a method of providing a health care service through a terminal according to embodiments disclosed in the present disclosure will be described below with reference to FIG. 4.

Description on Method of Providing Health Care Service Through Terminal

FIG. 4 is a flow chart illustrating a method of providing a health care service through a terminal according to embodiments disclosed in the present disclosure.

Referring to FIG. 4, a method of providing a health care service through a terminal according to embodiments disclosed in the present disclosure may be carried out as follows.

First, the terminal 100 may acquire information associated with a user's health care from an application associated with the health care service among a plurality of applications stored in the memory unit 160 of the terminal 100 (S110).

Next, the terminal 100 may determine whether or not the user's health care is normally carried out based on the information (S120).

Next, when the user's health care is not normally carried out(S130), or when the application associated with the health care service is not activated, the terminal 100 may display an indicator indicating an instruction for the user's health care on the screen of the terminal 100 (S140).

The plurality of applications refer to application programs executed on the terminal 100. In other words, they may have a concept similar to various programs used in a computer.

For example, the plurality of applications may be a documentation program, an Internet browser, a video playback program, various packages/on-line games, and the like, which are typically used in a computer. Furthermore, the plurality of applications may be executed by double-clicking each icon on the background or various menus.

As described above, the terminal 100 may acquire information associated with the user's health care from an application associated with the health care service among the plurality of applications.

For example, the application associated with the health care service may be an application for providing a health care service using a ubiquitous network capable of continuously monitoring locations, health conditions and workrates for a plurality of users in a particular region, implementing the health care and exercise care of the plurality of users, preventing an emergency situation in advance based on the location information, health conditions and workrates, and quickly responding to the occurrence of an emergency situation.

Information associated with the user's health care may be at least one of whether or not the user's blood glucose is measured or the user's blood glucose level, whether or not the user's blood pressure is measured or the user's blood pressure value, the user's food intake amount and the user's workrate.

The determination of whether or not the user's health care is normally carried out may be determined based on whether or not blood glucose is measured at the user's defined time, whether or not blood pressure is measured at the user's defined time, or whether or not at least one of the user's blood glucose level, blood pressure value, food intake amount and workrate is out of a target range.

For example, the terminal 100 may determine that the user's health care is not normally carried out in case the user does not measure blood glucose (or blood pressure), in case the user's blood glucose level (or blood pressure value) is out of a target blood glucose (or blood pressure) range, in case the user's food intake amount exceeds a target food intake amount or in case the user's workrate is less than a target workrate.

Hereinafter, a method of displaying an indicator indicating an instruction for the user's health care will be described below with reference to FIGS. 5 through 7.

### First Embodiment

A method of display an indicator according to a first embodiment disclosed in the present disclosure may include determining whether or not a user's health care is normally carried out based on information associated with the user's health care acquired from an application associated with a health care service, and displaying an indicator indicating an instruction for the user's health care on the screen of the terminal 100 when the user's health care is not normally carried out.

However, the indicator may be displayed on the screen of the terminal when the application associated with the health care service is not activated.

The first embodiment disclosed in the present disclosure may be implemented by part or combination of configurations or steps included in the foregoing embodiments or implemented by a combination of the embodiments. Hereinafter, the duplicate description thereof will be omitted to clearly describe the first embodiment.

Displaying of the indicator when the application associated with the health care service is not activated is to allow a user to recognize each execution status of health care even while performing another work (for example, performing another application) as well as during a period of time using a solution (or application) associated with the relevant health care service. In other words, it may be aimed to continuously receive encouragement on health care and provide a reminder capable of allowing self-awareness.

For example, a non-activated state of the application associated with the health care service may include a standby state during the operation period of the terminal 100 or an execution state (for example, execution of an Internet browser, etc.) of another application other than the application associated with the health care service.

FIG. 5 is an exemplary view illustrating an example of a method of displaying an indicator according to a first embodiment disclosed in the present disclosure.

Referring to FIG. 5, it is illustrated a method of displaying an indicator when the user of a health care service does not measure blood pressure (or blood glucose) on a predetermined schedule or does not accomplish a predetermined target value in the health care service.

FIG. 5 illustrates a case where the indicator is displayed in a standby state during the operation period of the terminal 100.

In this case, the indicator may be a character associated with a user's blood pressure (or blood glucose) device currently being used, and in this case, the terminal 100 may display the character while moving it on the screen of the terminal 100.

FIG. 5 illustrates a case where the indicator is a picture 210 of the user's children or grandchildren. In this case, the terminal 100 may display the picture 210 while moving it on the screen of the terminal 100.

Furthermore, the terminal 100 may record and store the voice of the user's children or grandchildren to allow the user to listen to the voice along with the picture 210. For example, the voice may be “Grandpa, please take blood pressure measurement. I'm very worried.” as illustrated in FIG. 5.

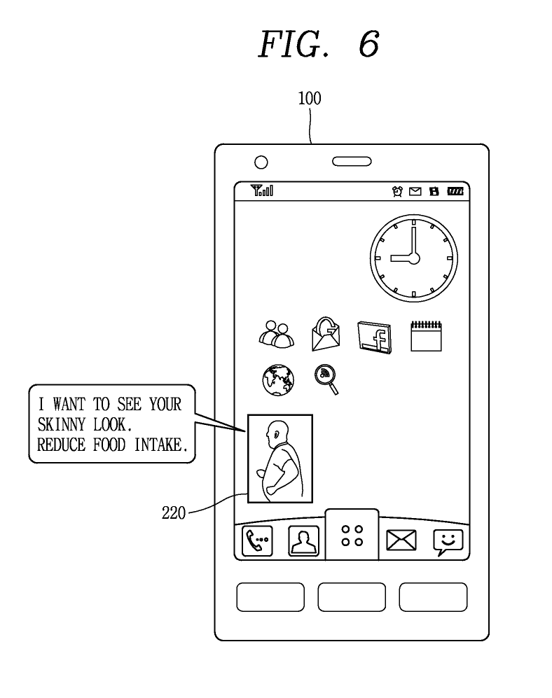

FIG. 6 is an exemplary view illustrating another example of a method of displaying an indicator according to a first embodiment disclosed in the present disclosure.

Referring to FIG. 6, it is illustrated a method of displaying an indicator when the user is a binge or picky eater without ingesting a wide variety of nutrients during a meal or the user's food intake amount exceeds a target value.

FIG. 6 also illustrates a case where the indicator is displayed in a standby state during the operation period of the terminal 100.

In this case, the indicator may be a moving dish or a character showing the user's fat look or the user's skinny look due to malnutrition. Furthermore, the terminal 100 may display the character while moving it on the screen of the terminal 100.

FIG. 6 illustrates a case where the indicator is a character indicating the user's fat appearance 220. In this case, the terminal 100 may display the character 220 while moving it on the screen of the terminal 100.

Furthermore, the terminal 100 may record and store a voice corresponding to the character 220 to allow the user to listen to the voice along with the character 220. For example, the voice may be “I want to see your skinny look. Reduce food intake.” as illustrated in FIG. 6.

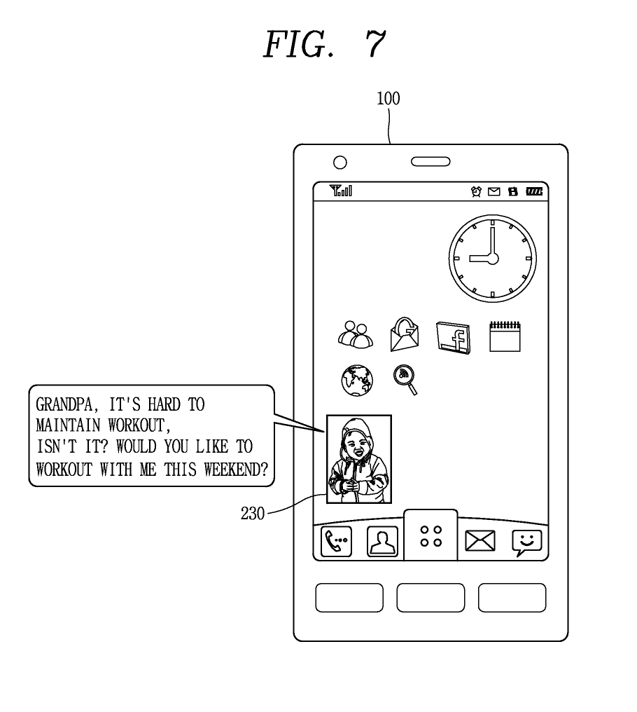

FIG. 7 is an exemplary view illustrating still another example of a method of displaying an indicator according to a first embodiment disclosed in the present disclosure.

Referring to FIG. 7, it is illustrated a method of displaying the indicator when the user does exercise intensely or lightly or the user is unable to accomplish his or her first fitness goal.

FIG. 7 also illustrates a case where the indicator is displayed in a standby state during the operation period of the terminal 100.

In this case, the indicator may be a character indicating a figure of the user being drenched in sweat with dehydration, a figure of the fitness trainer giving advice, a figure of the fitness trainer chasing the user with fitness equipment, and the like. Furthermore, the terminal 100 may display the character while moving it on the screen of the terminal 100.

FIG. 7 illustrates a case where the indicator is a picture230 of the user's children or grandchildren. In this case, the terminal 100 may display the picture 230 while moving it on the screen of the terminal 100.

Furthermore, the terminal 100 may record and store the voice of the user's children or grandchildren to allow the user to listen to the voice along with the picture 230. For example, the voice may be “Grandpa, it's hard to maintain workout, isn't it? Would you like to workout with me this weekend?” as illustrated in FIG. 7.

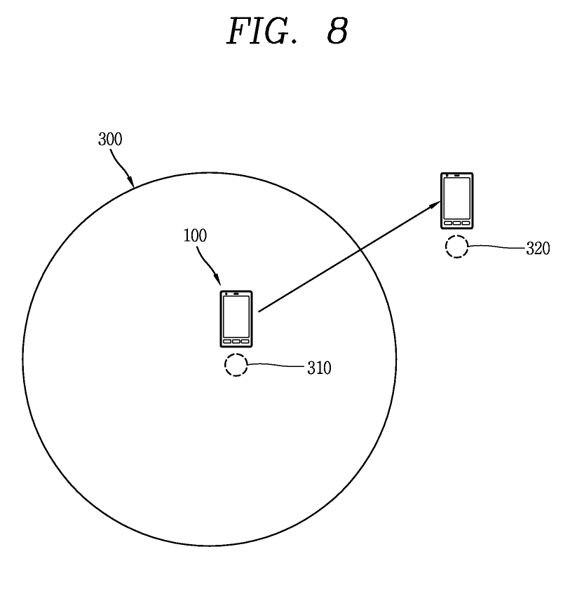

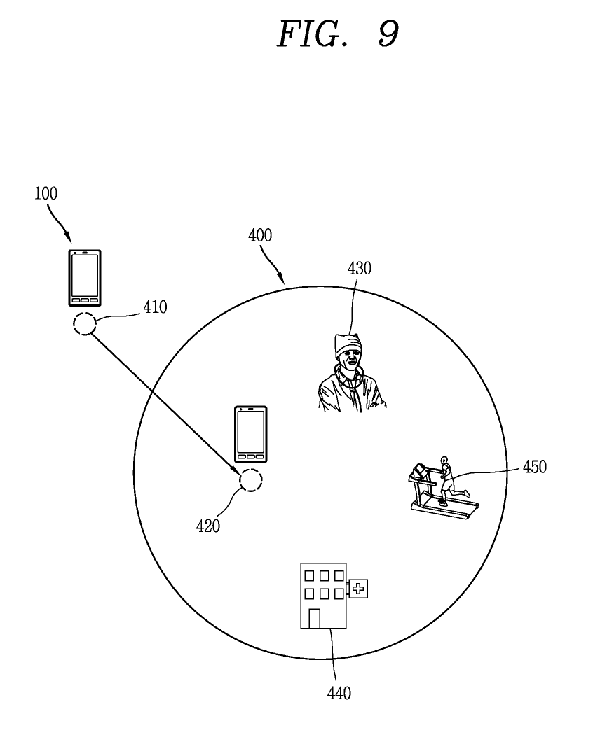

Hereinafter, a health care service method of providing a self-aware reminder based on the user's location will be described below with reference to FIGS. 8 and 9.

### Second Embodiment

A method of display an indicator according to second embodiment disclosed in the present disclosure relates to a health care service method of providing a self-aware reminder based on the user's location.

The second embodiment disclosed in the present disclosure may be implemented by part or combination of configurations or steps included in the foregoing embodiments or implemented by a combination of the embodiments. Hereinafter, the duplicate description thereof will be omitted to clearly describe the second embodiment.

In order to provide a self-aware reminder based on the user's location, the terminal 100 may acquire the location information of the terminal 100, and determine whether or not the terminal is located out of a predetermined range based on the location information.

The predetermined location range may be set in various ways. For example, it may be set by a provider of the health care service or a user of the health care service (for example, 500 m in radius from the user's residence, etc.).

When determined that the terminal 100 is located out of the predetermined range, the terminal 100 may display an indicator indicating an instruction for the user's health care on the screen of the terminal 100.

For example, a health care service based on the user's location may be implemented using a location based service (LBS).

LBS typically refers to a service using information on where an information device user is located. In other words, LBS may denote a location information based system and service comprehensively using mobile communication networks and IT technologies in a portable device such as a mobile phone or PDA. Furthermore, LBS is used to provide various information throughout every phase of life such as traffic information, location tracking information as well as product information based on the customer's location information.

The location based service (LBS) may typically include a cell-identification method using a mobile communication base station, a global positioning system (GPS) method using a satellite, and an assisted GPS (AGPS) method combined with both the cell-identification method and the GPS method.

Accordingly, according to a second embodiment disclosed in the present disclosure, the location information of the terminal 100 may be acquired based on at least one of a mobile communication network, a local area network and a global positioning system (GPS). In addition, it should be understood by those skilled in the art that various communication networks or positioning systems could be applicable to a health care service based on the location of the terminal 100 according to a second embodiment.

FIG. 8 is an exemplary view illustrating a health care service providing method for providing a self-aware reminder based on the user's location according to a second embodiment disclosed in the present disclosure.

Referring to FIG. 8, the terminal 100 is located at a first position 310 within a predetermined location range 300 at a specific time. When the terminal 100 is moved out of the predetermined location range 300 subsequent to the specific time, the terminal may be located at a second position 320 out of the predetermined location range 300.

In this case, it may be required to display an indicator indicating an instruction for the user's health care on the screen of the terminal 100.

For example, when the user of the health care service is moved out of a predetermined location range in a state that he or she has not measured blood pressure on a predetermined schedule, the terminal 100 may display an indicator indicating an instruction for the user's health care on the screen of the terminal 100. As an example, the instruction may be “Please go out after blood pressure measurement.”

Furthermore, for example, in case that the user of the health care service is a diabetic patient, when he or she is moved out of a predetermined location range in a state that he or she has not taken medicine (for example, insulin) on a predetermined schedule, the terminal 100 may display an indicator indicating an instruction for the user's health care on the screen of the terminal 100. As an example, the instruction may be “Please go out insulin administration.”

Furthermore, according to a modified second embodiment, in order to provide a self-aware reminder based on the user's location, the terminal 100 may acquired the location information of the terminal 100, and determine whether or not the terminal 100 enters a specific region based on the location information.

Furthermore, when the terminal 100 enters a specific region, the terminal 100 may display an indicator indicating health care information associated with the specific region on the screen of the terminal 100.

The specific region may be determined based on various criteria. For example, the specific region may be a geographical region in which the terminal 100 is located. Furthermore, for example, the specific region may be a region in which the institution, center, management center or the like is located. In addition, it should be understood by those skilled in the art that various criteria for providing a health care service could be applicable to determine the specific region.

According to a modified second embodiment, health care information associated with the specific region may be at least one of a hospital, a pharmacy, a sports center and a health care center associated with the health care service located at the specific region.

FIG. 9 is an exemplary view illustrating a health care service providing method for providing a self-aware reminder based on the user's location according to a modified second embodiment disclosed in the present disclosure.

Referring to FIG. 9, the terminal 100 is located at a third position 410 out of a predetermined specific region 400 at a specific time. When the terminal 100 is moved into the specific region 400 subsequent to the specific time, the terminal may be located at a fourth position 420.

In this case, the terminal 100 may be required to display an indicator indicating health care information associated with the specific region on the screen of the terminal 100.

For example, when a hospital 430 is located in the specific region 400 as illustrated in FIG. 9, the terminal 100 may display an indicator indicating, “You have entered a region with a hospital” on the screen of the terminal 100.

Furthermore, for example, when a pharmacy 440 is located in the specific region 400, the terminal 100 may display an indicator indicating, “You have entered a region with a pharmacy” on the screen of the terminal 100.

Furthermore, for example, when a sports center 450 is located in the specific region 400, the 100 may display an indicator indicating, “You have entered a region with a sports center” on the screen of the terminal 100.

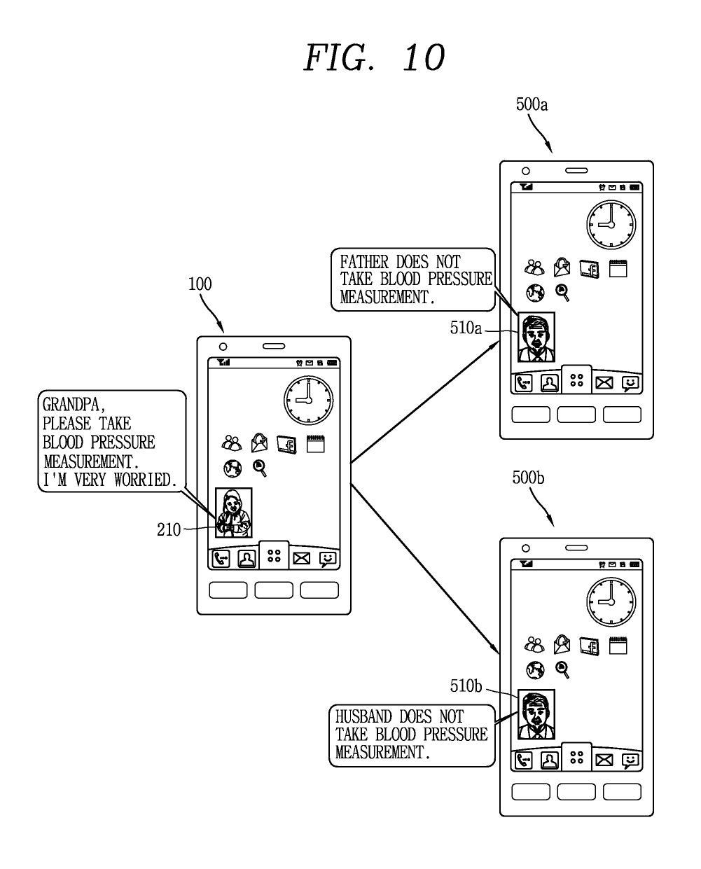

Hereinafter, a method of displaying an indicator by means of another terminal connected to the terminal 100 in a wired or wireless manner will be described with reference to FIG. 10.

### Third Embodiment

A method of displaying an indicator according to a third embodiment disclosed in the present disclosure relates to a health care service providing method of providing a reminder for health care to a terminal possessed (or provided) by another person related to a user of the health care service.

The third embodiment disclosed in the present disclosure may be implemented by part or combination of configurations or steps included in the foregoing embodiments or implemented by a combination of the embodiments. Hereinafter, the duplicate description thereof will be omitted to clearly describe the third embodiment.

According to a third embodiment, the terminal 100 may generate a control signal for controlling a second terminal associated with a health care service to display an indicator indicating that the user's health care is abnormal on the screen of the second terminal.

Here, the second terminal may be connected to the terminal in a wired or wireless manner.

Then, the terminal 100 may transmit the control signal to the second terminal, and the second terminal may receive the control signal. Next, the second terminal may display an indicator indicating that the user's health care is abnormal on the screen of the second terminal based on the control signal.

The second terminal may be a terminal possessed (or provided) by another person associated with a user of the health care service. For example, the another person may be a family member having a lot of interest in the user's health status.

FIG. 10 is an exemplary view illustrating a method of displaying an indicator according to a third embodiment disclosed in the present disclosure.

Referring to FIG. 10, an indicator according to the foregoing embodiments is displayed on the terminal 100 possessed (or provided) by a user of the health care service. In other words, the terminal 100 may determine whether or not the user's health care is normally carried out based on information associated with a user's health care acquired from an application associated with a health care service, and display an indicator indicating an instruction for the user's health care on the screen of the terminal 100 when the user's health care is not normally carried out. FIG. 10 illustrates a case where the user does not measure his or her blood pressure at a predetermined time, wherein the instruction displays “Grandpa, please take blood pressure measurement. I'm very worried.”

According to the third embodiment, the integral reactor 10 may generate a control signal for allowing a second terminal 500 connected to the terminal in a wired or wireless manner to display an indicator indicating that the user's health care is abnormal.

As described above, the terminal 100 may transmit the control signal to the second terminal 500, and the second terminal 500 may receive the control signal to display an indicator indicating that the user's health care is abnormal on the screen of the second terminal 500 based on the control signal.

There may exist a plurality of second terminals 500, and in case of FIG. 10, the second terminal 500 may include two terminals 500a, 500b.

Furthermore, FIG. 10 illustrates a case where one 500a of the two terminals 500a, 500b is possessed by the user's child, and another one 500b thereof is possessed by the user's spouse.

In this case, the indicator may be a character 510a, 510b indicating a figure of grandfather. Furthermore, content indicating that the user's health care is abnormal may be “Father does not take blood pressure measurement” in case of the terminal 500a possessed by the user's child, and may be “Husband does not take blood pressure measurement in case of the terminal 500b possessed by the user's spouse.

The foregoing method may be implemented in a medium that can be read by a computer or similar device using software, hardware, or any combination thereof.

For hardware implementation, the foregoing methods may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units designed to perform the functions described herein. For example, the foregoing methods may be implemented in the controller 180 of the terminal 100.

For software implementation, the embodiments such as procedures or functions may be implemented together with separate software modules. The software modules may perform at least one function or operation described herein. Software codes can be implemented by a software application written in any suitable programming language. The software codes may be stored in the memory 160 and executed by the controller 180.

The scope of the present disclosure is not limited to the embodiments disclosed in the present specification, and thus various forms of modifications, variations, and improvements can be made in the present disclosure without departing from the concept of the invention, and within the scope of the appended claims.

1. A method of providing a health care service through a terminal, the method comprising:
acquiring information associated with a user's health care from an application associated with the health care service among a plurality of applications stored in a memory unit of the terminal;
determining whether or not the user's health care is normally carried out based on the information; and
displaying an indicator indicating an instruction for the user's health care on a screen of the terminal when the user's health care is not normally carried out,
wherein the indicator is displayed on the screen of the terminal when the application associated with the health care service is not activated.

2. The method of claim 1, wherein the information is at least one of whether or not the user's blood glucose is measured or the user's blood glucose level, whether or not the user's blood pressure is measured or the user's blood pressure value, the user's food intake amount and the user's workrate.

3. The method of claim 2, wherein said determining whether or not the user's health care is normally carried out is determined based on whether or not blood glucose is measured at the user's defined time, whether or not blood pressure is measured at the user's defined time, or whether or not at least one of the user's blood glucose level, blood pressure value, food intake amount and workrate is out of a target range.

4. The method of claim 1, further comprising:
acquiring the location information of the terminal; and
determining whether or not the terminal is located out of a predetermined range based on the location information,
wherein the indicator is displayed on the screen of the terminal when the terminal is located out of the predetermined range.

5. The method of claim 1, further comprising:
acquiring the location information of the terminal;
determining whether or not the terminal enters a specific region based on the location information; and
displaying an indicator indicating health care information associated with the specific region on the screen of the terminal when the terminal enters the specific region.

6. The method of claim 5, wherein the health care information associated with the specific region is at least one of a hospital, a pharmacy, a sports center and a health care center associated with the health care service located at the specific region.

7. The method of claim 4, wherein the location information of the terminal is acquired based on at least one of a mobile communication network, a local area network, and a global positioning system (GPS).

8. The method of claim 1, further comprising:
generating a control signal for controlling that a second terminal associated with a health care service displays an indicator indicating that the user's health care is abnormal on the screen of the second terminal,
wherein the second terminal is connected to the terminal in a wired or wireless manner.

9. A terminal, comprising:
a display unit configured to display a screen;
a memory unit configured to store a plurality of applications; and
a controller configured to acquire information associated with a user's health care from an application associated with the health care service among a plurality of applications stored in the memory unit, determine whether or not the user's health care is normally carried out based on the information, and display an indicator indicating an instruction for the user's health care on a screen of the terminal when the user's health care is not normally carried out,
wherein the indicator is displayed on the screen when the application associated with the health care service is not activated.

10. The terminal of claim 9, wherein the information is at least one of whether or not the user's blood glucose is measured or the user's blood glucose level, whether or not the user's blood pressure is measured or the user's blood pressure value, the user's food intake amount and the user's workrate.

11. The terminal of claim 9, wherein said determining whether or not the user's health care is normally carried out is determined based on whether or not blood glucose is measured at the user's defined time, whether or not blood pressure is measured at the user's defined time, or whether or not at least one of the user's blood glucose level, blood pressure value, food intake amount and workrate is out of a target range.

12. The terminal of claim 9, wherein the controller acquires the location information of the terminal, determines whether or not the terminal is located out of a predetermined range based on the location information, and displays the indicator on the screen of the terminal when the terminal is located out of the predetermined range.

13. The terminal of claim 9, wherein the controller acquires the location information of the terminal, determines whether or not the terminal enters a specific region based on the location information, and displays an indicator indicating health care information associated with the specific region on the screen of the terminal when the terminal enters the specific region.

14. The terminal of claim 13, wherein the health care information associated with the specific region is at least one of a hospital, a pharmacy, a sports center and a health care center associated with the health care service located at the specific region.

15. The terminal of claim 12, wherein the location information of the terminal is acquired based on at least one of a mobile communication network, a local area network, and a global positioning system (GPS).

16. The method of claim 5, wherein the location information of the terminal is acquired based on at least one of a mobile communication network, a local area network, and a global positioning system (GPS).

17. The terminal of claim 13, wherein the location information of the terminal is acquired based on at least one of a mobile communication network, a local area network, and a global positioning system (GPS).
